(19) United States
(12) Patent Application Publication
(10) Pub. No.: US 2017/0225383 A1
(43) Pub. Date: Aug. 10, 2017

(54) METHOD OF MANUFACTURING SHAFT-SHAPE COMPOSITE MEMBER

(71) Applicant: Honda Motor Co., Ltd., Tokyo (JP)

(72) Inventors: Kazuhiro Taneda, Wako-shi (JP); Nobuhiro Yamada, Wako-shi (JP); Hiroshi Kiyomoto, Wako-shi (JP)

(73) Assignee: Honda Motor Co., Ltd., Tokyo (JP)

(21) Appl. No.: 15/417,368

(22) Filed: Jan. 27, 2017

(30) Foreign Application Priority Data
Feb. 9, 2016 (JP) 2016-022383

(51) Int. Cl. B29C 51/14; B29C 70/68; B29C 70/20; B29C 51/26; B29C 51/12

(52) U.S. Cl. CPC B29C 51/14; B29C 51/261; B29C 51/12; B29C 70/20; B29C 70/682; B29K 2105/08

(57) ABSTRACT

To provide a method of manufacturing a shaft-shape composite member in which a bent section is suitably treated. A plurality of thermosetting fiber-reinforced resin materials made of a UD material is supplied to a bending section of a mold in a state of being aligned in parallel to an axial direction of a cavity to form a UD material layer. Subsequently, after forming a tubular member having the UD material layer by the metal mold, by thermally curing the tubular member, the shaft-shape composite member having the bent section can be obtained. When manufacturing the shaft-shape composite member, a cross-section orthogonal to the axial direction of each of the fiber-reinforced resin materials has a circular shape.

### CROSS REFERENCES TO RELATED APPLICATIONS

The present application claims priority under 35 U.S.C. §119 to Japanese Patent Application No. 2016-022383, filed Feb. 9, 2016, entitled “Method of Manufacturing Shaft-Shape Composite Member.” The contents of this application are incorporated herein by reference in their entirety.

### TECHNICAL FIELD

The present disclosure relates to a method of manufacturing a shaft-shape composite member having a bent section.

### BACKGROUND

For example, Japanese Unexamined Patent Application Publication No. JP 7-276521 discloses a molding method for a tubular member using a fiber-reinforced prepreg. In the molding method, the fiber-reinforced resin material wound around a mandrel (core) is preheated to form a tubular member of a semi-cured state, and the tubular member is cured by being arranged in a metal mold and by being heated while applying pressure, thereby molding a desired tubular member.

As the fiber-reinforced resin material, there are, for example, a uni-directional (UD) material (a unidirectional reinforcing member) in which fibers are aligned in one direction, and a 45° material in which fibers are aligned in two directions orthogonal to each other. Among them, a bent section of the tubular member formed of the 45° materials has high rigidity against torsion, and meanwhile, as illustrated in FIG. 10, the rigidity is lowered against the bending load input from a direction perpendicular to an axial direction of the tubular member 100. Meanwhile, as illustrated in FIG. 11, if an angle (a fiber orientation angle) in an extending direction of the fiber with respect to the axial direction of the tubular member is about 0° to 10°, the tubular member formed of the UD material has high rigidity against the bending load input. Therefore, it is preferable to mold the tubular member (for example, a suspension arm and a stabilizer) having a bent section using the UD material.

### SUMMARY

Incidentally, in the molding method of the tubular member disclosed in Japanese Unexamined Patent Application Publication No. JP 7-276521, when setting the tubular member of a semi-cured state to the recess of the metal mold, the tubular member is bent in accordance with the shape of the bent section formed in the metal mold.

In the bent section of the tubular member, a difference in length between a length of an inner circumferential side and a length of an outer circumferential side occurs. Therefore, when using a sheet-shaped or tape-shaped fiber-reinforced resin material, it is not possible to follow the bent shape, and wrinkles or the like occur on the inner circumferential side of the bent section due to the difference in length. The wrinkles may cause a risk of impairing the performance (rigidity against the bending load input) of the UD material.

It is preferable to provide a method of manufacturing a shaft-shape composite member in which a bent section is suitably treated.

One aspect of the present disclosure provides a method for manufacturing a shaft-like composite member having a bent section, the method including: setting a plurality of thermosetting fiber-reinforced resin materials made of a UD material to a bending section of a metal mold, in a state of being aligned in parallel to an axial direction of a cavity; forming a tubular member having the UD material layer by the metal mold; and obtaining the shaft-like composite member having the bent section by thermally curing the tubular member, wherein a cross-section orthogonal to the axial direction of each of the fiber-reinforced resin materials has a circular shape.

Accordingly, when manufacturing the shaft-like composite member, since the plurality of UD materials is set in a state of being aligned in parallel to the bending section, it is possible to absorb the difference between the inner and outer circumferences of the bent portion, and by setting the cross-section orthogonal to the axial direction of the thermosetting fiber-reinforced resin material as a circular shape, as compared to the case of the rectangular cross-section, the follow-up property of the fiber-reinforced resin material in the bent section becomes higher, which makes it possible to suppress the occurrence of wrinkles in the bent section. Further, by using the thermosetting fiber-reinforced resins, it possible to suppress the occurrence of wrinkles in the bent section. Asa result, it is possible to suppress decreases in the bending rigidity and the torsional rigidity of the bent section of the shaft-like composite member.

Further, one aspect has a process of forming a plurality of laminated UD material layers, after forming the UD material layer of an outermost layer by each of the fiber-reinforced resin materials, further, by sticking each of the fiber-reinforced resin materials to the inner side of the UD material layer in a state of being aligned in parallel to the axial direction of the cavity.

Accordingly, by laminating the UD material layers to a plurality of layers, for example, it is possible to provide a configuration in which the fiber of the second layer located inside the first layer enters between the fibers of the outermost first layer. This makes it possible to fill the gaps between the plurality of laminated UD material layers, and it is possible to improve the rigidity of the bent section of the shaft-like composite member.

Further, the plurality of laminated UD material layers may have a cross-sectional outer diameter of the fiber-reinforced resin material of the inner layer that is smaller than a cross-sectional outer diameter of the fiber-reinforced resin material of the outer layer, between the adjacent inner and outer layers.

Accordingly, by setting the cross-sectional outer diameter of the fiber-reinforced resin material constituting the inner layer to be smaller than the outer side, the filling rate of the fiber-reinforced resin material between the UD material layers becomes higher, and it is possible to further improve the rigidity of the bent section of the shaft-like composite member.

In the present disclosure, for example, since the bent section is properly processed, it is possible to obtain a shaft-like composite member having desired rigidity and strength against the bending load input.

### BRIEF DESCRIPTION OF THE DRAWINGS

FIG. 1 is a perspective view of an arrangement device of a fiber-reinforced resin material and a metal mold that are provided in a method for manufacturing a shaft-like composite member according to an embodiment of the present disclosure.

FIG. 2 is a perspective view in which the arrangement device illustrated in FIG. 1 is viewed from the back side.

FIG. 3 is an exploded perspective view in which a pressing unit is disassembled from a regulating member and an end guide member.

FIG. 4A is a schematic diagram illustrating each fiber-reinforced resin material that is set into a cavity of the metal mold by the arrangement section, and FIG. 4B is an enlarged view of a part B illustrated in FIG. 4A.

FIG. 5 is a schematic diagram illustrating each fiber-reinforced resin material that is stuck to the cavity by the pressing unit.

FIG. 6 is a schematic view illustrating a state in which each fiber-reinforced resin material is stuck to the inside of the UD material layer L1, after a UD material layer L1 as the outermost layer is formed.

FIG. 7 is a schematic view illustrating a modified example in which an outer diameter of a wire-reinforced resin material of an outer UD material layer and an outer diameter of a fiber-reinforced resin material of an inner UD material are configured to be different from each other.

FIG. 8A is a schematic view illustrating a state of setting two half members in the cavity of the metal mold, FIG. 8B is a schematic view illustrating a state of imparting pressure to the set half members and thermally curing the half members, and FIG. 8C is a schematic diagram illustrating a state in which two half members are integrally coupled to each other.

FIG. 9 is a perspective view of the shaft-like composite member that is a finished product.

FIG. 10 is a diagram which is provided for description of the bending input to the tubular member.

FIG. 11 is a characteristic diagram illustrating a relation between the fiber orientation angle and the rigidity of the UD material.

### DETAILED DESCRIPTION

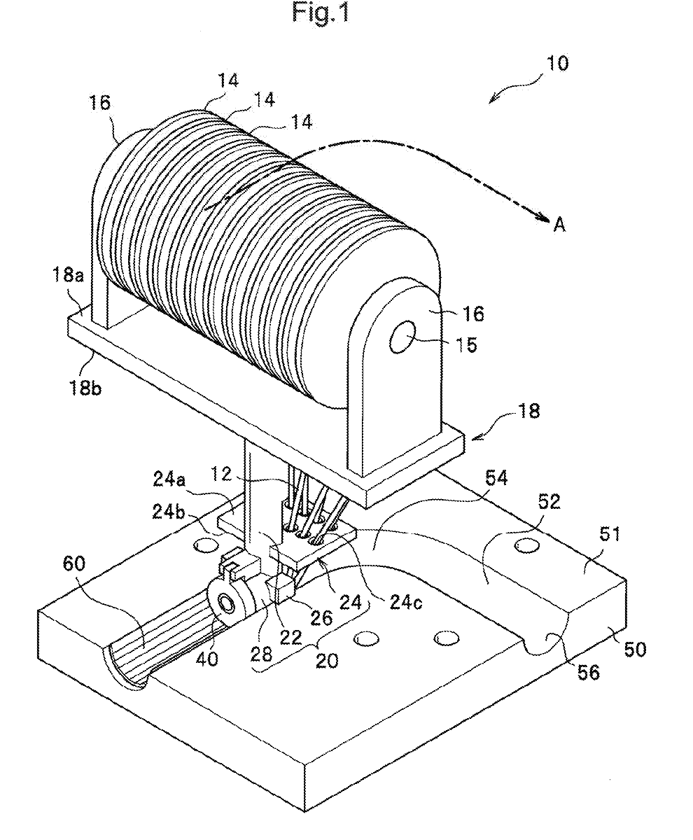

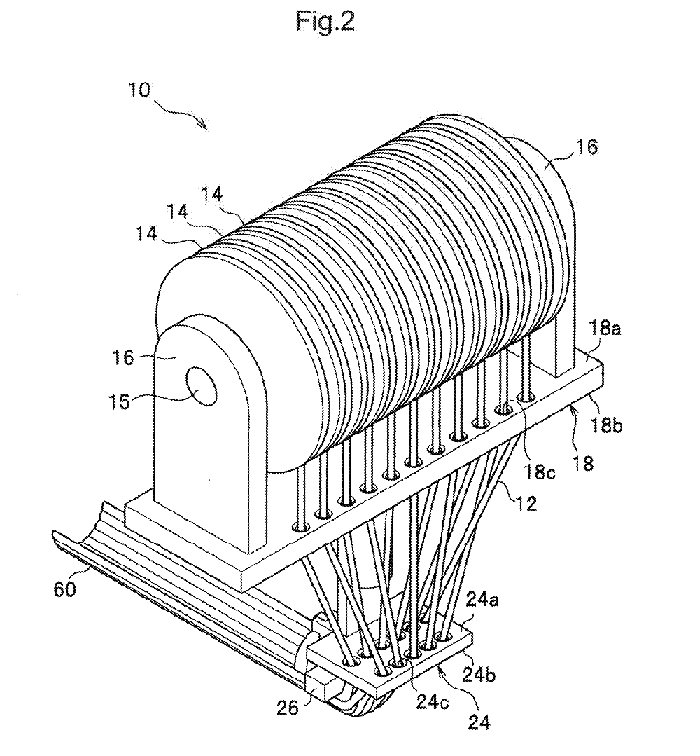

Next, embodiments of the present disclosure will be described in detail with reference to the drawings. FIG. 1 is a perspective view of an arrangement device of a fiber-reinforced resin material and a metal mold that are provided in a method for manufacturing a shaft-like composite member according to an embodiment of the present disclosure. FIG. 2 is a perspective view in which the arrangement device illustrated in FIG. 1 is viewed from the back side.

As illustrated in FIGS. 1 and 2, an arrangement device 10 of a fiber-reinforced resin material 12 (hereinafter, simply referred to as an arrangement device 10) includes a plurality of bobbins 14 which has a fiber bundle, has a fiber-reinforced resin material 12 (uncured, semi-cured) having adhesiveness wound around a surface and can individually rotate, a guide unit 20 in which the respective fiber-reinforced resin materials 12 drawn from the plurality of bobbins 14 are aligned in parallel along a recess of a metal mold 50, and a pressing unit 40 that presses the respective fiber-reinforced resin materials 12 disposed by the guide unit 20 to the metal mold 50.

The arrangement device 10 is attached to a driving device (not illustrated), for example, an arm tip of a multi-axis robot as an end effecter. The multi-axis robot moves the arrangement device 10, for example, along the direction of an arrow A in FIG. 1, along a movement route that is taught in advance by a predetermined program.

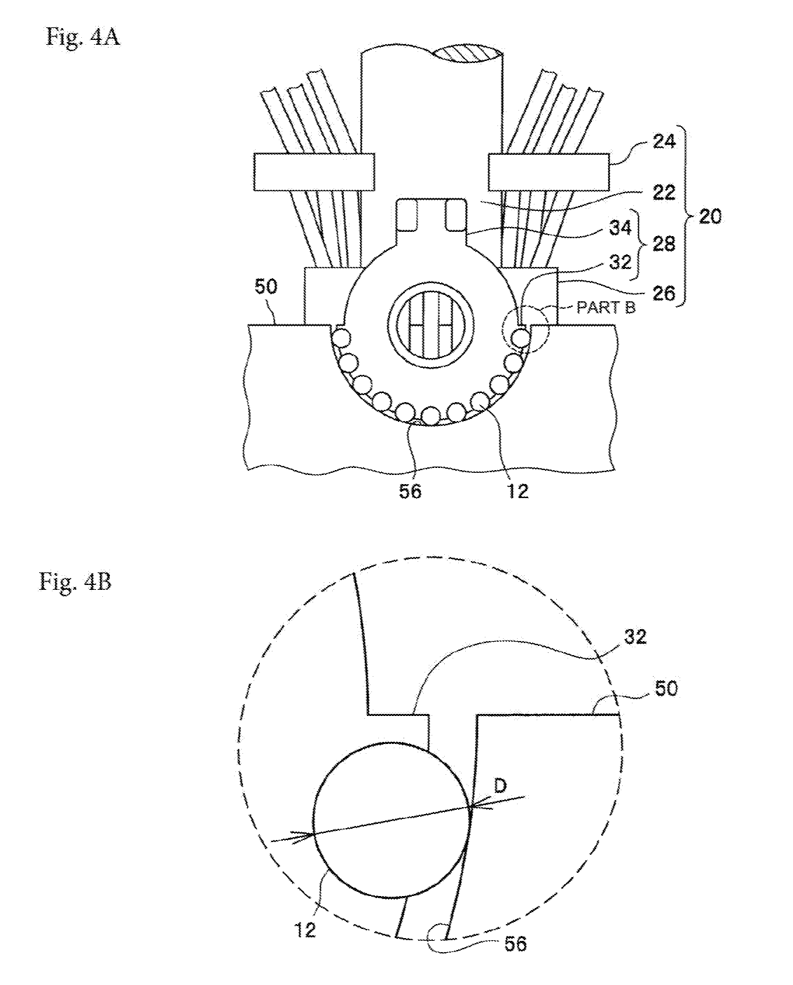

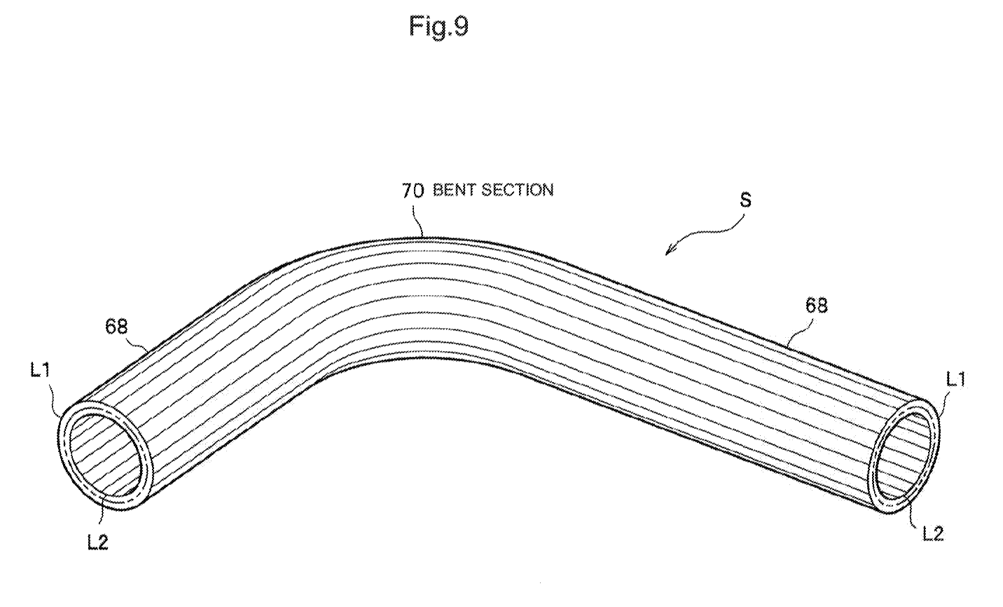

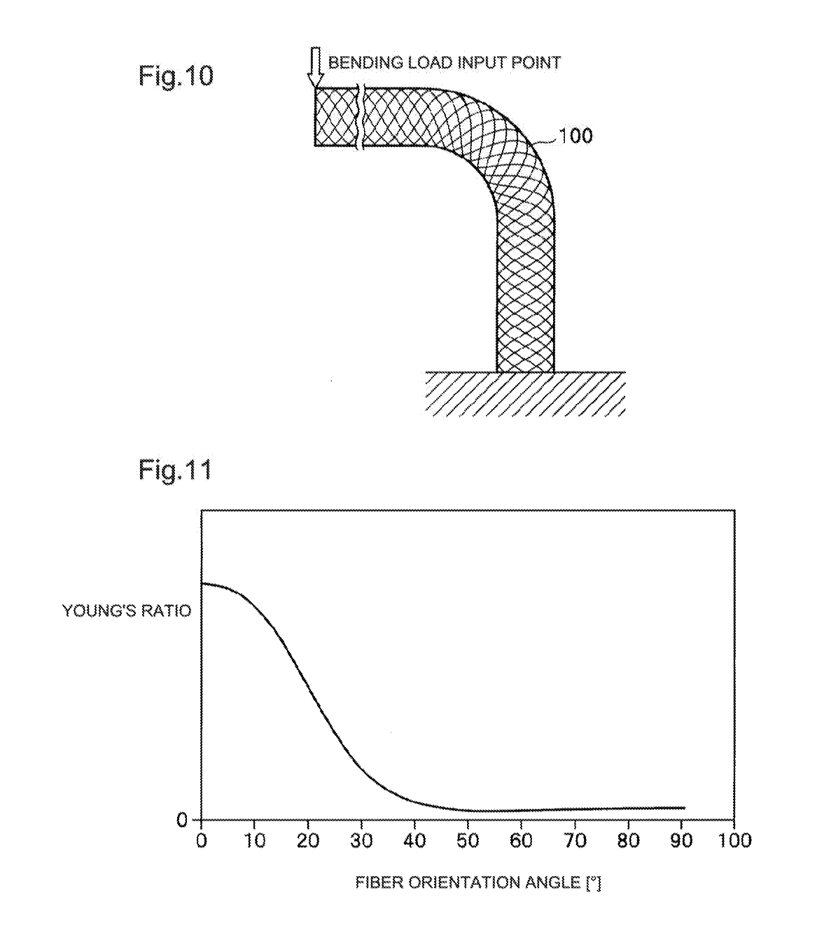

The fiber-reinforced resin material 12 is a material of a tubular member that is an intermediate molded body for manufacturing a shaft-like composite member S (see FIG. 9 to be described later), and is a tow prepreg that is made up of a plurality of filaments in which a “fiber” as the reinforcing material is impregnated with “resin” as a matrix material. Further, a cross-section orthogonal to the axial direction of the respective fiber-reinforced resin materials 12 has a “circular shape” (see FIG. 4B). Since the cross-section has a circular shape, when using the fiber-reinforced resin material 12 formed into a tape shape, it is possible to provide a thickness at the time of lamination. Accordingly, it is possible to reduce the number of laminations, and it is possible to improve the arrangement workability.

As the “fiber”, inorganic fibers such as carbon fibers, glass fibers, boron fibers, alumina fibers, silicon carbide fibers and silicon nitride fibers, and organic fibers such as aramid fibers, polyarylate fibers and polyethylene fibers are used. In addition, metal fibers such as titanium fibers, amorphous fibers and stainless steel fibers maybe used. Further, plural kinds of fibers maybe used in combination. As the “resin”, thermosetting resins such as epoxy resins, unsaturated polyester resins, polyurethane resins, diallyl phthalate resins, phenol resins and polyimide resin are used. The fiber-reinforced resin made of the thermosetting resin may suppress the occurrence of wrinkles at the time of molding since the follow-up to the metal mold is easy in the state (a room temperature) before molding, as compared to the fiber-reinforced resin made of the thermoplastic resin. Therefore, it is possible to achieve a reduction in the rigidity of the molded article.

As illustrated in FIGS. 1 and 2, the fiber-reinforced resin materials 12 are wound around a plurality of bobbins 14 (in FIGS. 1 and 2, the bobbins 14 which are aligned laterally in a row) in a drawable state. Each bobbin 14 is rotatably supported by a shaft member 15 inserted through the center of the bobbin 14. The shaft member 15 laterally bridges between the pair of support members 16 facing each other.

That is, a plurality of bobbins 14 is disposed to be arranged in parallel in a direction perpendicular to the movement direction of the arrangement device 10. Each bobbin 14 is supported by a pair of support members 16 via the shaft member 15, and is provided to be individually rotatable about the shaft member 15. Further, the inner diameter of the hole of each bobbin 14 through which the shaft member 15 is inserted is formed to be larger than the outer diameter of the shaft member 15. Thus, each bobbin 14 is in a free state of being rotatable with respect to the shaft member 15.

The lower end of the support member 16 is fixed to one surface (an upper surface) 18a of a plate 18 that has a rectangular shape in a plan view. As illustrated in FIG. 2, the plate 18 is formed with a plurality of through-holes 18c penetrating the other surface (a lower surface) 18b on the opposite side from the one surface 18a. The plurality of through-holes 18c is disposed linearly in a row along the longitudinal direction of the plate 18. The fiber-reinforced resin material 12 drawn from the bobbin 14 is inserted into each through-hole 18c from the one surface 18a side toward the other surface 18b side.

A guide unit 20 is provided on the other surface 18b side of the plate 18. The guide unit 20 is configured to include a columnar member 22, an intermediate guide member 24, a regulating member 26, and a terminal end guide member 28. The upper end of the columnar member 22 is fixed to the other surface 18b of the plate 18.

The intermediate guide member 24 is a rectangular plate-like member that is attached to the lower end side of the columnar member 22. The intermediate guide member 24 is formed with a plurality of through-holes 24c that penetrate the other surface (the lower surface) 24b on the opposite side from the one surface (the upper surface) 24a. As illustrated in FIG. 2, the plurality of through-holes 24c is disposed linearly in two parallel rows along the longitudinal direction of the intermediate guide member 24.

The fiber-reinforced resin material 12 drawn from the bobbin 14 and passing through the through-hole 18c of the plate 18 is inserted into each through-hole 24c, toward the one surface 24b side from the other surface 24a side. The intermediate guide member 24 collects the fiber-reinforced resin materials 12 expanding in single row through the through-hole 18c of the plate 18 in two rows, and guides the fiber-reinforced resin materials 12 toward the terminal end guide member 28.

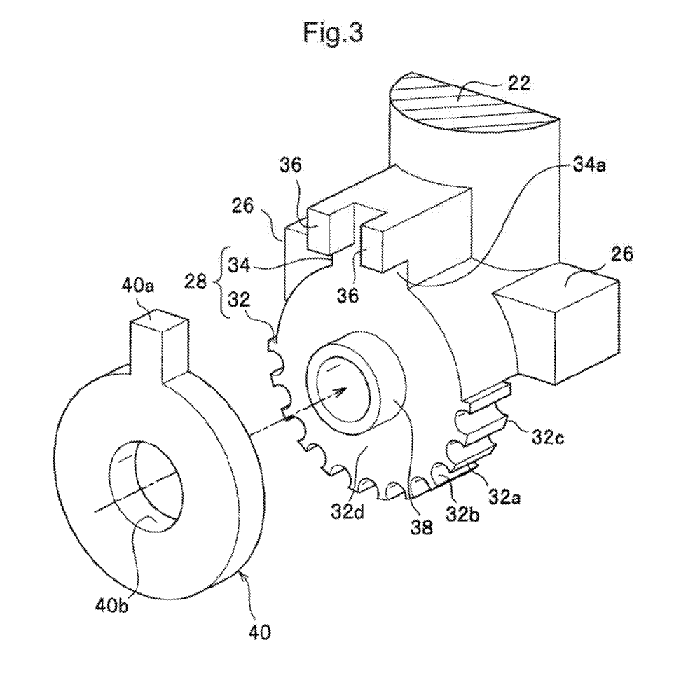

Here, the regulating member 26 and the terminal end guide member 28 constituting the guide unit 20, and the pressing unit 40 will be described. FIG. 3 is an exploded perspective view in which the pressing unit is disassembled from the regulating member and the terminal end guide member.

As illustrated in FIGS. 1 and 3, the regulating member 26 and the terminal end guide member 28 are disposed at the other end (the lower end) of the columnar member 22. Among them, the regulating member 26 protrudes in one direction and its opposite direction of the radial direction of the columnar member 22, respectively. The regulating member 26 regulates the position of the terminal end guide member 28 in the cavity 52 of the metal mold 50, by the lower surface of the regulating member 26 coming into contact with the divided surface 51 of the metal mold 50.

As illustrated in FIG. 3, the terminal end guide member 28 has an arrangement section 32 and a rubber attachment section 34. The arrangement section 32 is a member that enters the cavity 52 of the metal mold 50, and is partially formed with a cross-sectional shape which is substantially identical to a cross-sectional shape of the cavity 52. In this embodiment, the arrangement section 32 is a semicircular plate-like member.

The outer circumferential curved surfaces 32a of the arrangement section 32 faces an inner circumferential curved surface 56 of the cavity 52 of the metal mold 50 (see FIG. 1). On the outer circumferential curved surface 32a of the arrangement section 32, a plurality of grooves 32b parallel to the axial direction of the arrangement section 32 is formed from one surface (back surface) 32c to the other surface (front surface) 32d of the arrangement section 32. The cross-sectional shape of each groove 32b is formed in an arc shape in correspondence with the cross-sectional shape of the fiber-reinforced resin material 12. The fiber-reinforced resin material 12 which is drawn from the bobbin 14 and passes through the through-hole 18c of the plate 18 and the through-hole 24c of the intermediate guide member 24 is inserted through the groove 32b, toward the other surface 32d side from one surface 32c side.

Further, in the arrangement section 32, a surface area of the other surface (front surface) 32d is preferably smaller than a surface area of one surface (back surface) 32c. That is, it is preferable that the outer circumferential curved surface 32a of the arrangement section 32 be tilted toward the one surface 32c side from the other surface 32d side.

The rubber attachment section 34 has a rubber attachment surface 34a that forms the same surface as the other surface 32d side of the arrangement section 32. The rubber attachment surface 34a is provided with a pair of protrusions 36. In addition, an annular protruding section 38 is provided across the rubber attachment surface 34a of the rubber attachment section 34 and the other surface 32d of the arrangement section 32.

The pressing unit 40 is a disk-shaped rubber member. A circular arc of the pressing unit 40 is formed slightly smaller in diameter than a circular arc of the outer circumferential curved surface 32a of the arrangement section 32. A small piece 40a projecting outward in the radial direction is provided around the pressing unit 40. A through-hole 40b is formed at the center of the pressing unit 40. The small piece 40a is inserted between a pair of protrusions 36 provided in the rubber attachment section 34. An annular protruding section 38 provided in the rubber attachment section 34 and the arrangement section 32 is inserted through the through-hole 40b. Accordingly, the pressing unit 40 is fixed to the rubber attachment section 34 and the arrangement section 32.

The arrangement device 10 and the metal mold 50 provided in the manufacturing of the shaft-like composite member according to the present embodiment are basically configured as above, and their function and effect will be described below.

A method for setting the fiber-reinforced resin material 12 into the cavity 52 of the metal mold 50 using the arrangement device 10 will be described.

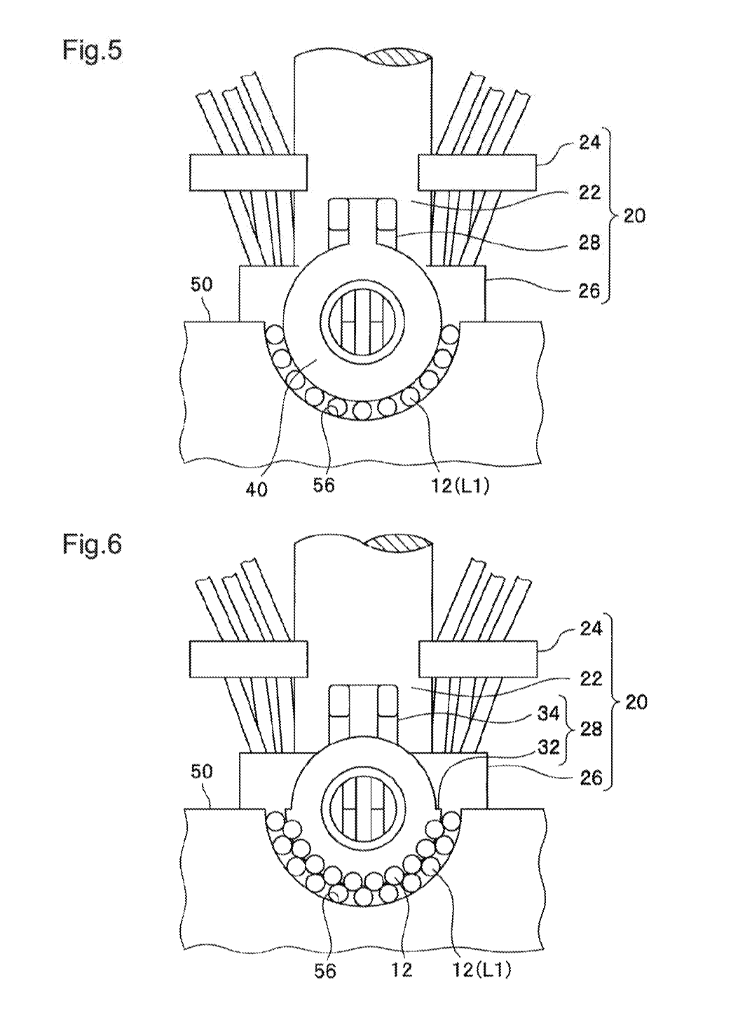

FIG. 4A is a schematic diagram illustrating each fiber-reinforced resin material that is set into the cavity of the metal mold by the arrangement section. FIG. 4B is an enlarged view of a part B illustrated in FIG. 4A. FIG. 5 is a schematic diagram illustrating each fiber-reinforced resin material that is stuck to the cavity by the pressing unit. FIG. 6 is a schematic view illustrating a state in which each fiber-reinforced resin material is stuck to the inside of the UD material layer L1, after a UD material layer L1 as the outermost layer is formed.

First, the terminal end guide member 28 of the guide unit 20 illustrated in FIG. 1 is fed into the cavity 52 of the metal mold 50. At this time, the ends of the respective fiber-reinforced resin materials 12 passed through the respective grooves 32b of the arrangement section 32 are stuck to the inner circumferential curved surface 56 of the metal mold 50. Further, by driving the multi-axis robot (not illustrated) to move the arrangement device 10 along the surface of the metal mold 50 as indicated by the arrow A in FIG. 1, the arrangement section 32 is moved along the shape of the cavity 52.

Since the ends of the respective fiber-reinforced resin materials 12 are stuck to the inner circumferential curved surface 56 of the metal mold 50, the fiber-reinforced resin material 12 drawn from the bobbin 14 with the movement of the arrangement device 10 pulls the fiber-reinforced resin material 12 that is wound around the bobbin 14. Then, the rotational force is imparted to the bobbin 14, and the bobbin 14 rotates about the shaft member 15 as the center of rotation. As a result, the fiber-reinforced resin material 12 having a predetermined length is drawn from the bobbin 14.

As illustrated in FIG. 4A, the fiber-reinforced resin material 12 drawn from the bobbin 14 is set on the inner circumferential curved surface 56 of the metal mold 50, via the through-hole 18c of the plate 18, the through-hole 24c of the intermediate guide member 24 and the groove 32b of the arrangement section 32. At this time, the fiber-reinforced resin material 12 is set in a state of being aligned in parallel to the axis direction of the cavity 52.

As illustrated in FIG. 5, at the time of the set of the fiber-reinforced resin material 12, the respective fiber-reinforced resin materials 12 are pressed toward the inner circumferential curved surface 56 of the cavity 52 of the metal mold 50 by the pressing unit 40. Thus, the half member 60 (see FIG. 1) is gradually formed. The half member 60 is a UD material in which the fiber-reinforced resin materials 12 are aligned in one direction. Further, at the time of completion of the half member 60, the cross-section orthogonal to the axial direction of the fiber-reinforced resin material 12 is held in a circular shape.

The bending section 54 of the metal mold 50 (see FIG. 1) has a shape corresponding to the bent section 70 of a finished product the shaft-like composite member S (see FIG. 9 to be described later), and has a difference between the inner and outer circumferences. The outer circumference of the bending section 54 is longer than the inner circumference. When the arrangement section 32 moves on the bending section 54, the rotational speeds of each bobbin 14 are different from each other. Since the bobbins 14 in which the fiber-reinforced resin materials 12 are wound around the outer circumferential side of the bending section 54 rotate greater than the bobbin 14 in which the fiber-reinforced resin materials 12 are wound around the inner circumferential side of the bending section 54, the drawing amount of the fiber-reinforced resin materials 12 increases.

In this way, according to the arrangement device 10, since it is possible to form the half member 60 which accurately reflects the difference between the inner and outer circumferences of the bending section 54, it is possible to prevent wrinkles from being generated in the bending section 54 of the half member 60.

After the UD material layer L1 serving as the outermost layer is formed, further, each of fiber-reinforced resin materials 12 drawn from the bobbin 14 is stuck to the inside of the UD material layer L1 in the state of being aligned in parallel to the axial direction of the cavity 52 (see FIG. 6). Each fiber-reinforced resin material 12 stuck to the inside of the UD material layer L1 is pressed toward the outer UD material layer L1 by the pressing unit 40. Thus, a UD material layer L2 (see FIG. 9) is formed by the respective fiber-reinforced resin materials 12 which are stuck to the inside of the UD material layer L1. As a result, the half members 60 which are laminated with the UD material layer L1 and the UD material layer L2 including the two inner and outer layers are formed.

For example, the half members 60 including the UD material layers L1, L2, . . . Ln; (n is a natural number) of the plural layers are obtained by sequentially laminating the respective fiber-reinforced resin material 12 that are further drawn from the bobbin 14 on the inner side. Further, the UD material layers of two to four layers may be preferably laminated.

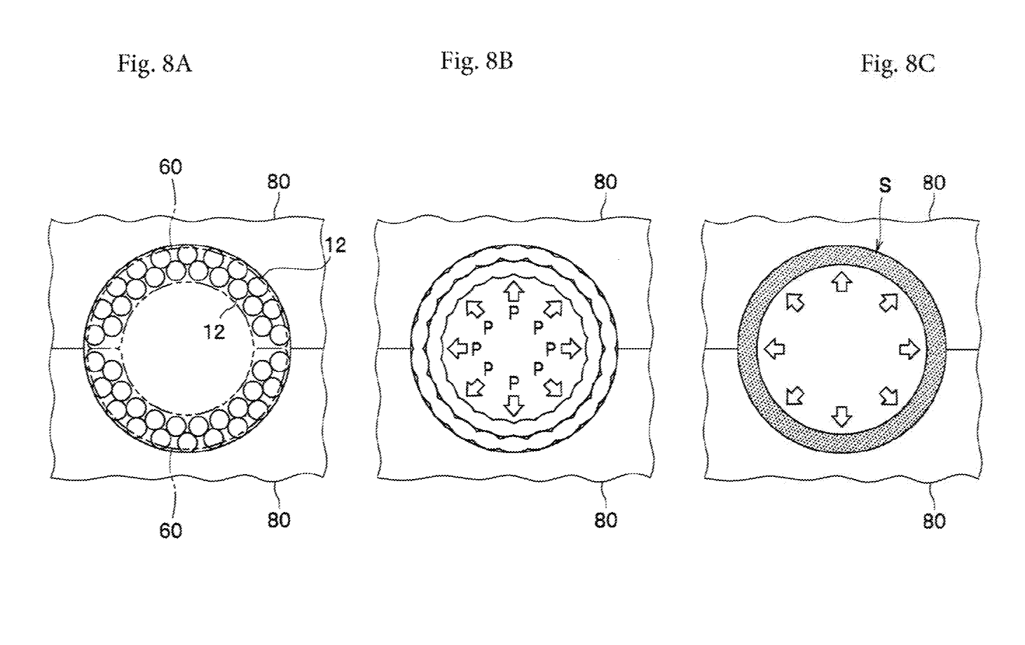

FIG. 8A is a schematic view illustrating a state of setting the two half members in the cavity of the metal mold, FIG. 8B is a schematic view illustrating a state of imparting pressure to the set half members and thermally curing the half members, and FIG. 8C is a schematic diagram illustrating a state in which two half members are integrally coupled to each other. FIG. 9 is a perspective view of the shaft-like composite member that is a finished product.

After forming the two half members 60 using the arrangement device 10 and a pair of metal molds 50, as illustrated in FIG. 8A, the two half members 60 are set into the cavity of the pair of metal molds 80 enclosing a balloon-like pressure application means (not illustrated) in a state of keeping the circular cross-sectional shape. Subsequently, as illustrated in FIG. 8B, the two half members 60 are thermally cured, while imparting the pressure P (see outlined arrow) in the state of closing the pair of metal molds 80. As a result, the respective fiber-reinforced resin materials 12 disposed in parallel are sufficiently connected without gaps, and the two half members 60 are integrally coupled with each other along their mating surfaces, thereby forming a shaft-like composite member S (e.g., a suspension arm and a stabilizer) (FIG. 8C). As illustrated in FIG. 9, the shaft-like composite member S is made up of, for example, a straight line section 68 and the bent section 70.

In the present embodiment, since the cross-section orthogonal to the axial direction of the thermosetting fiber-reinforced resin materials 12 has a circular shape (see FIG. 4B), as compared to the case of the rectangular cross-section, the follow-up property of the fiber-reinforced resin material 12 in the bent section 70 becomes higher, which makes it possible to suppress the occurrence of wrinkles in the bent section 70. As a result, in the present embodiment, it is possible to suppress decreases in the bending rigidity and torsional rigidity of the bent section 70 of the shaft-like composite member S.

In the present embodiment, by laminating the UD material layers to a plurality of layers, for example, it is possible to provide a configuration in which the fiber of the second layer located inside the first layer enters between the fibers of the outermost first layer. In the present embodiment, this makes it possible to fill the gaps between the plurality of laminated UD material layers, and it is possible to improve the rigidity of the bent section 70 of the shaft-like composite member S.

In other words, in the bent section of a conventional shaft-like composite member, a difference in length occurs between the length of the inner peripheral side and the length of the outer peripheral side. However, in the present embodiment, by setting the cross-section orthogonal to the axial direction of the thermosetting fiber-reinforced resin material 12 as a circular shape, and by laminating the plurality of UD material layers, it is possible to smoothly absorb the difference in lengths. As a result, it is possible to improve the bending rigidity and the torsional rigidity in the bent section 70, by suppressing the occurrence of wrinkles in the bent section 70 of the shaft-like composite member S.

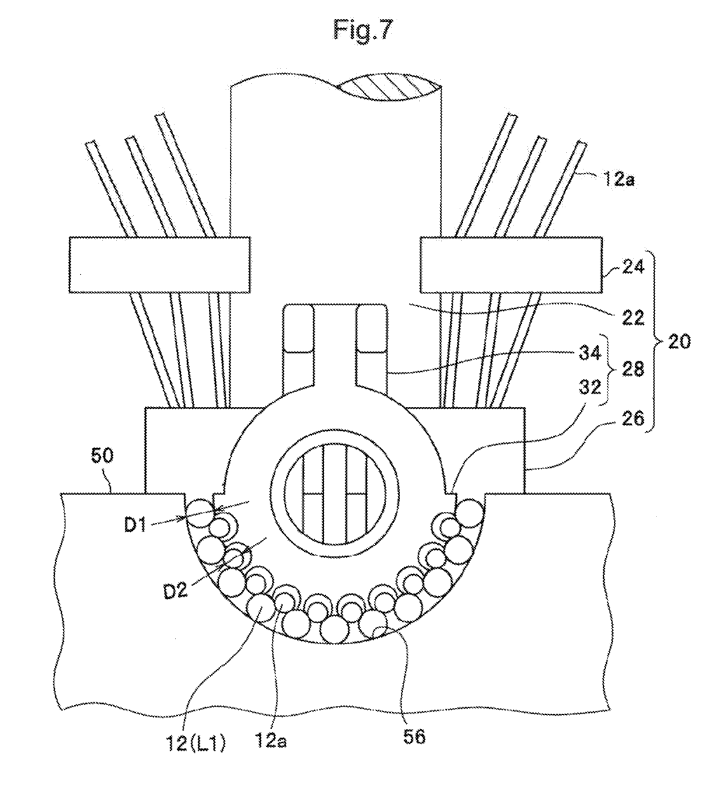

FIG. 7 is a schematic view illustrating a modified example in which an outer diameter of a wire-reinforced resin material of an outer UD material layer and an outer diameter of a fiber-reinforced resin material of an inner UD material layer are formed to have different diameters. Further, FIG. 7 illustrates a state in which after the UD material layer L1 as the outermost layer is formed, respective fiber-reinforced resin materials having the different diameter are stuck to the inside of the UD material layer L1.

The above embodiment illustrates a case where the outer diameters D (see FIG. 4B) of the fiber-reinforced resin materials 12 of each layer are uniformly formed between the plurality of adjacent inner and outer layers, but is not limited thereto. For example, between the adjacent inner and outer layers, a cross-sectional outer diameter (D2) of the fiber-reinforced resin material 12a of the inner layer may be smaller than a cross-sectional outer diameter (D1) of the fiber-reinforced resin material 12 of the outer layer (D1>D2) (see FIG. 7).

In other words, the outer diameter D of the fiber-reinforced resin materials 12 of each inner layer may be gradually reduced from the UD material layer L1 as the outermost layer toward the inner UD material layer L2 . . . . For example, in the case of the configuration of the UD material layer of the inner and outer three layers, the outer diameter D2 of the fiber-reinforced resin material of the UD material layer L1 located inside the UD material layer L1 is reduced as compared to the outer diameter D1 of the fiber-reinforced resin material 12 of the outer UD material layer L1. In addition, an outer diameter D3 of the fiber-reinforced resin material 12 of the UD material layer L3 located on the inner side of the UD material layer L2 is reduced as compared to the outer diameter D2 of the fiber-reinforced resin material 12 of the outer UD material layer L2 (D1>D2>D3).

In the modified example illustrated in FIG. 7, by setting the cross-sectional outer diameter D2 of the fiber-reinforced resin material 12a constituting the inner layer to be smaller than the cross-sectional outer diameter D1 of the fiber-reinforced resin material 12 constituting the outer layer (D1>D2), the filling factor of the fiber-reinforced resin material 12a becomes higher, and it is possible to further improve the rigidity of the bent section 70 of the shaft-like composite member S.

Further, as a method for manufacturing the shaft-like composite member S that is a finished product using the two half members 60, various manufacturing methods are considered, without being particularly limited. In the present embodiment, the method for setting the two half members 60 in the cavity of the recessed shape of the metal mold 80 and thermally curing the two half members 60 by imparting the pressure has been described (FIGS. 8(a) to 8(c)), but it is not limited thereto. For example, a method for setting the two half members 60 on the outer circumference of a shaft-like mold (a convex die) having a bent section in parallel to the axial direction and thermally curing the two half members 60 may be used. Further, the cross-section of the shaft-like composite member S in a direction perpendicular to the axis is not limited to a circular tube shape, and for example, maybe a hollow square tubular shape or an elliptical shape. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

We claim:

1. A method of manufacturing a shaft-shape composite member having a bent section, the method comprising steps of:
(i) preparing a mold having a cavity including a bending section;
(ii) setting a plurality of thermosetting fiber-reinforced resin materials made of a uni-directional (UD) material to the bending section of the mold, in a state that the plurality of thermosetting fiber-reinforced resin materials are aligned in parallel to an axial direction of the cavity;
(iii) forming a tubular member having a layer of the UD material by the mold; and
(iv) obtaining the shaft-shape composite member having the bent section by thermally curing the tubular member,
wherein a cross-section orthogonal to the axial direction of each of the fiber-reinforced resin materials has a circular shape.

2. The method of manufacturing a shaft-shape composite member according to claim 1, further comprising:
forming a plurality of laminated UD material layers including forming the layer of the UD material as an outermost layer by each of the fiber-reinforced resin materials, and then, sticking each of the fiber-reinforced resin materials to an inner side of the outermost layer so as to be aligned in parallel to the axial direction of the cavity.

3. The method of manufacturing a shaft-shape composite member according to claim 2, wherein the plurality of laminated UD material layers is configured that an inner layer of the plurality of laminated UD material layers includes a cross-sectional outer diameter of the fiber-reinforced resin material that is smaller than a cross-sectional outer diameter of the fiber-reinforced resin material of an outer layer of the plurality of laminated UD material layers, the inner layer and the outer layer being adjacent to each other.

4. The method of manufacturing a shaft-shape composite member according to claim 1, wherein the step (ii) comprises supplying the plurality of thermosetting fiber-reinforced resin materials independently from each other to the mold.

5. The method of manufacturing a shaft-shape composite member according to claim 4, wherein the step (ii) comprises supplying the plurality of thermosetting fiber-reinforced resin materials independently from each other to the bending section such that one of the plurality of thermosetting fiber-reinforced resin materials disposed on an outer circumference side of the bending section is longer than another one of the plurality of thermosetting fiber-reinforced resin materials disposed on an inner circumference side of the bending section.

6. The method of manufacturing a shaft-shape composite member according to claim 5, wherein the plurality of thermosetting fiber-reinforced resin materials are supplied to the mold simultaneously.

7. The method of manufacturing a shaft-shape composite member according to claim 2, wherein the plurality of laminated UD material layers includes an outer layer and an inner layer adjacent to the outer layer,
the fiber-reinforced resin materials of the inner layer are disposed in a staggered manner with respect to the fiber-reinforced resin materials of the outer layer.
